(19) United States
(12) Patent Application Publication
(10) Pub. No.: US 2024/0037779 A1
(43) Pub. Date: Feb. 1, 2024

(54) POSITION DETECTION DEVICE, POSITION DETECTION METHOD, AND STORAGE MEDIUM STORING POSITION DETECTION PROGRAM

(71) Applicant: Mitsubishi Electric Corporation, Tokyo (JP)

(72) Inventors: Takeo KAWAURA, Tokyo (JP); Takahiro KASHIMA, Tokyo (JP); Sohei OSAWA, Tokyo (JP)

(73) Assignee: Mitsubishi Electric Corporation, TOKYO (JP)

(21) Appl. No.: 18/376,865

(22) Filed: Oct. 5, 2023

Related U.S. Application Data
(63) Continuation of application No. PCT/JP2021/016290, filed on Apr. 22, 2021.

(51) Int. Cl. G06T 7/70; G06V 20/62; G06T 11/00; G06V 20/50; G06V 30/19

(52) U.S. Cl. CPC G06T 7/70; G06V 20/63; G06T 11/00; G06V 20/50; G06V 30/19; G06T 2207/30232; G06T 2207/30196

(57) ABSTRACT

A position detection device includes processing circuitry: to receive an image captured by a monitoring camera, to execute a process for detecting a person in the image, and to output two-dimensional camera coordinates indicating a position of the detected person; to transform the two-dimensional camera coordinates to three-dimensional coordinates; to recognize a character string on a nameplate of a device in a wearable camera image captured by a wearable camera; to search a layout chart of the device for the recognized character string; to determine two-dimensional map coordinates based on a position where the character string is found when the recognized character string is found in the layout chart, and to calculate the two-dimensional map coordinates based on the three-dimensional coordinates when the recognized character string is not found in the layout chart; and to output image data in which position information is superimposed on a map.

### CROSS-REFERENCE TO RELATED APPLICATION

This application is a continuation application of International Application No. PCT/JP2021/016290 having an international filing date of Apr. 22, 2021.

### BACKGROUND OF THE INVENTION

### 1. Field of the Invention

The present disclosure relates to a position detection device, a position detection method and a position detection program.

### 2. Description of the Related Art

There has been proposed a system including a plurality of monitoring cameras provided on a ceiling of a factory or the like so that a range as image capturing ranges of the plurality of monitoring cameras combined together includes a target area without any omission. In this system, position coordinates of a worker as a person moving in the target area are acquired based on images captured by a large number of monitoring cameras fixed to face the same direction. See Patent Reference 1, for example.

Patent Reference 1: Japanese Patent Application Publication No. 2017-34511 (Paragraph 0025 and FIG. 2, for example).

However, in the above-described conventional system, there is a problem in that a large number of monitoring cameras installed to face the same direction are necessary to detect the position coordinates of the worker.

### SUMMARY OF THE INVENTION

An object of the present disclosure is to provide a position detection device, a position detection method and a position detection program that make it possible to resolve the above-described problem.

A position detection device in the present disclosure includes processing circuitry to receive an image captured by a monitoring camera, to execute a process for detecting a person in the image, and to output two-dimensional camera coordinates indicating a position of the detected person; to transform the two-dimensional camera coordinates to three-dimensional coordinates represented in a predetermined common coordinate system; to recognize a character string on a nameplate of a device in a wearable camera image captured by a wearable camera when the wearable camera is worn by the person; to search a layout chart of the device for the recognized character string; to determine two-dimensional map coordinates based on a position where the character string is found when the recognized character string is found in the layout chart, and to calculate the two-dimensional map coordinates based on the three-dimensional coordinates when the recognized character string is not found in the layout chart; and to acquire a map and to output image data in which position information on the two-dimensional map coordinates is superimposed on the map.

According to the present disclosure, the position coordinates of the worker can be detected with a simple configuration.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing a plurality of monitoring cameras as a configuration used for position detection by a position detection device according to a first embodiment;

FIGS. 2A and 2B are diagrams showing two-dimensional coordinates of a person detected based on a plurality of images captured by the plurality of monitoring cameras on a map;

FIG. 3 is a functional block diagram schematically showing the configuration of the position detection device according to the first embodiment;

FIG. 4 is a diagram showing a hardware configuration of the position detection device according to the first embodiment;

FIG. 5 is a flowchart showing a process executed by a person detection unit of the position detection device according to the first embodiment;

FIG. 6 is a flowchart showing a process executed by a two-dimensional/three-dimensional coordinate transformation unit of the position detection device according to the first embodiment;

FIG. 7 is a flowchart showing a process executed by a map coordinate determination unit of the position detection device according to the first embodiment;

FIG. 8 is a diagram showing monitoring cameras and a mobile terminal as a configuration used for the position detection by a position detection device according to a second embodiment;

FIG. 9A is a diagram showing the two-dimensional coordinates of a person detected based on images captured by the monitoring cameras on a map, and FIG. 9B is a diagram showing the two-dimensional coordinates of a person detected by pedestrian dead reckoning (PDR) on a map;

FIG. 10 is a functional block diagram schematically showing the configuration of the position detection device according to the second embodiment;

FIG. 11 is a flowchart showing a process executed by a coordinate calculation unit of the position detection device according to the second embodiment;

FIG. 12 is a flowchart showing a process executed by a map coordinate determination unit of the position detection device according to the second embodiment;

FIG. 13 is a diagram showing monitoring cameras and a wearable camera as a configuration used for the position detection by a position detection device according to a third embodiment;

FIG. 14A is a diagram showing an example of an instrument panel, an instrument, and a nameplate;

FIG. 14B is a diagram showing 2D map coordinates detected by using an image of the nameplate, on a map;

FIG. 15 is a functional block diagram schematically showing the configuration of the position detection device according to the third embodiment;

FIG. 16 is a flowchart showing a process executed by a character recognition unit of the position detection device according to the third embodiment; and

FIG. 17 is a flowchart showing a process executed by a character search unit of the position detection device according to the third embodiment.

### DETAILED DESCRIPTION OF THE INVENTION

A position detection device, a position detection method, and a position detection program according to each embodiment will be described below with reference to the drawings. The following embodiments are just examples and it is possible to appropriately combine embodiments and appropriately modify each embodiment. Throughout the drawings, components identical or similar to each other are assigned the same reference character.

### First Embodiment

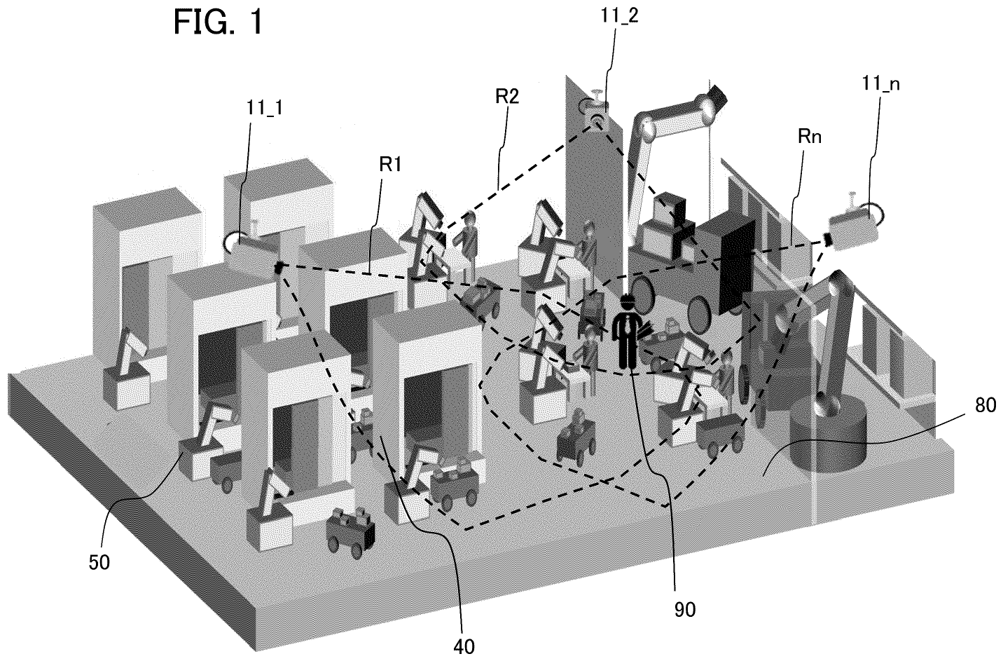

FIG. 1 is a diagram showing a plurality of monitoring cameras 11_1-11_n (n is a positive integer) as a configuration used for position detection by a position detection device 10 according to a first embodiment. The monitoring cameras 11_1-11_n have been installed in a predetermined area 80. Instrument panels and machines 50 have been set in the area 80. The monitoring cameras 11_1-11_n are fixed cameras. While the monitoring cameras 11_1-11_n can also be PTZ cameras capable of swiveling, the monitoring cameras 11_1-11_n in this case need to be equipped with a function of notifying the position detection device 10 about camera parameters. The monitoring cameras 11_1-11_n respectively capture images of image capturing ranges R1-Rn and transmit images I₁-Iₙ to the position detection device 10. The position detection device 10 calculates two-dimensional (2D) map coordinates (X, Y) of a person 90 based on the images I₁-Iₙ and generates image data for making a display device display information indicating the 2D map coordinates (X, Y) on a map 81 of the area 80. The area is the inside of a factory, for example. The person 90 is a worker, for example.

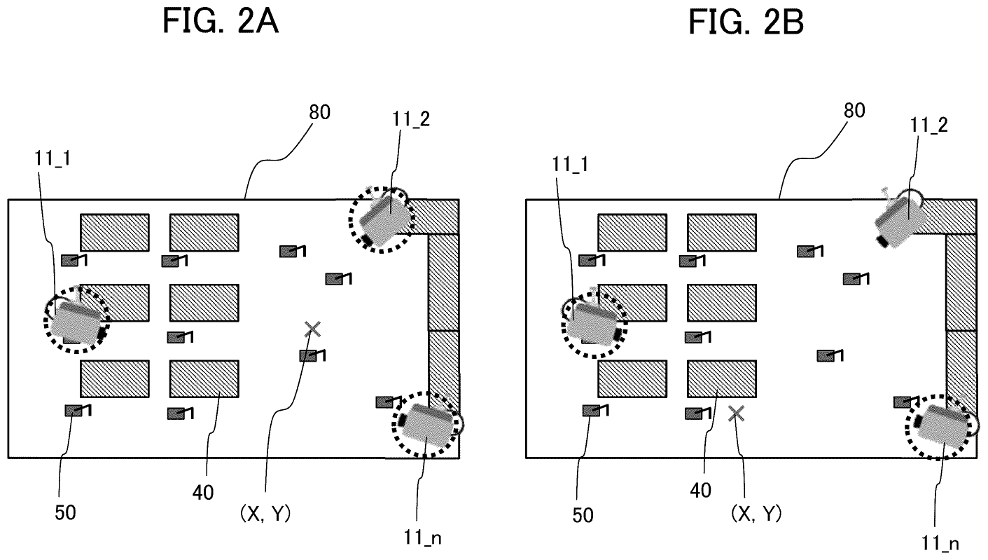

FIGS. 2A and 2B are diagrams showing the 2D map coordinates (X, Y) of the person 90 detected based on a plurality of images I₁-Iₙ captured by the plurality of monitoring cameras 11_1-11_n on the map 81 of the area 80. FIG. 2A shows an example of the 2D map coordinates (X, Y) calculated by using three monitoring cameras 11_1, 11_2 and 11_n, and FIG. 2B shows an example of the 2D map coordinates (X, Y) calculated by using two monitoring cameras 11_1 and 11_n. The map 81 of the area 80 in FIGS. 2A and 2B is acquired from an external storage device. However, the map 81 may also be stored in a storage device in the position detection device 10.

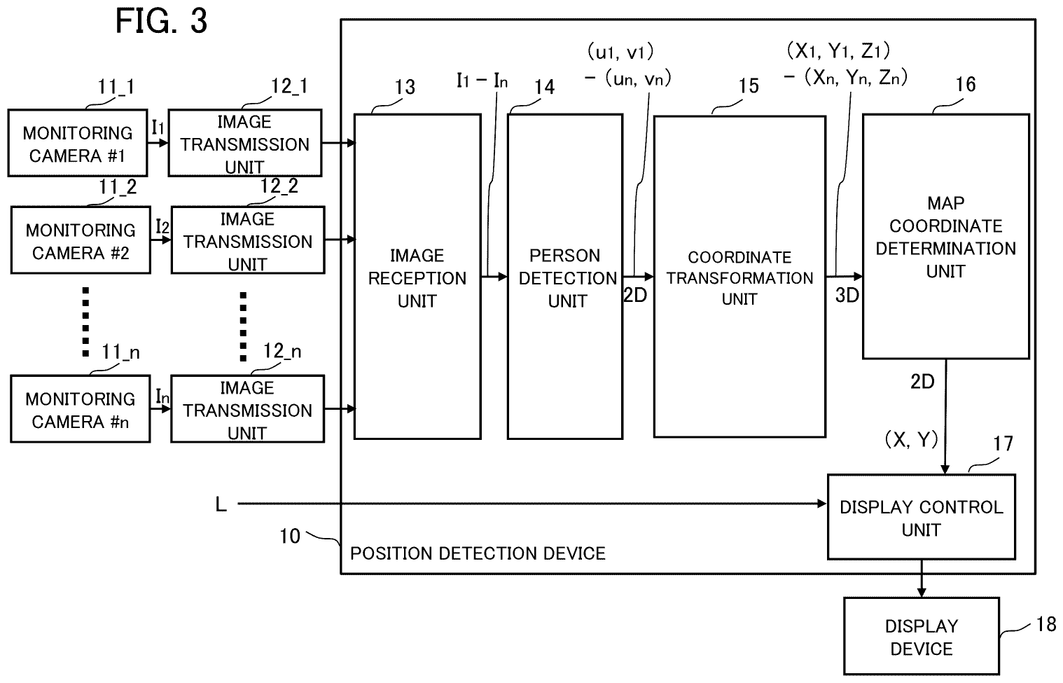

FIG. 3 is a functional block diagram schematically showing the configuration of the position detection device 10 according to the first embodiment. The position detection device 10 is a device capable of executing a position detection method according to the first embodiment. The position detection device 10 is capable of executing the position detection method according to the first embodiment by executing a position detection program. As shown in FIG. 3, the position detection device 10 includes an image reception unit 13, a person detection unit 14, a coordinate transformation unit 15, a map coordinate determination unit 16 and a display control unit 17.

The image reception unit 13 receives the plurality of images I₁-Iₙ captured by the plurality of monitoring cameras 11_1-11_n and transmitted by image transmission units 12_1-12_n and outputs the images I₁-Iₙ to the person detection unit 14. The image reception unit 13 is referred to also as a communication circuit or a communication interface.

The person detection unit 14 receives the images I₁-Iₙ, executes a process for detecting the person 90 in each of the images I₁-Iₙ, and outputs a plurality of sets of two-dimensional (2D) camera coordinates (u₁, v₁)-(uₙ, vₙ) indicating the position of the detected person 90. Coordinate systems of the 2D camera coordinates (u₁, v₁)-(uₙ, vₙ) differ from each other.

The coordinate transformation unit 15 is a coordinate transformation unit that transforms two-dimensional (2D) coordinates to three-dimensional (3D) coordinates. The coordinate transformation unit 15 transforms the plurality of sets of 2D camera coordinates (u₁, v₁)-(uₙ, vₙ)to a plurality of sets of 3D coordinates (X₁, Y₁, Z₁)-(Xₙ, Yₙ, Zₙ) represented in a predetermined common coordinate system. The common coordinate system is a world coordinate system, for example.

The map coordinate determination unit 16 generates 2D map coordinates (X, Y) based on the plurality of sets of 3D coordinates (X₁, Y₁, Z₁)-(Xₙ, Yₙ, Zₙ). The map coordinate determination unit 16 calculates the 2D map coordinates (X, Y) by using a summation average of coordinate values of the plurality of sets of 3D coordinates (X₁, Y₁, Z₁)-(Xₙ, Yₙ, Zₙ).

The display control unit 17 outputs image data in which position information on the 2D map coordinates (X, Y) is superimposed on the map 81 of the area 80. A display device 18 displays the map 81 of the area 80 and the position information on the 2D map coordinates (X, Y). In the example of FIG. 3, the map 81 is displayed based on map information L acquired from an external storage device.

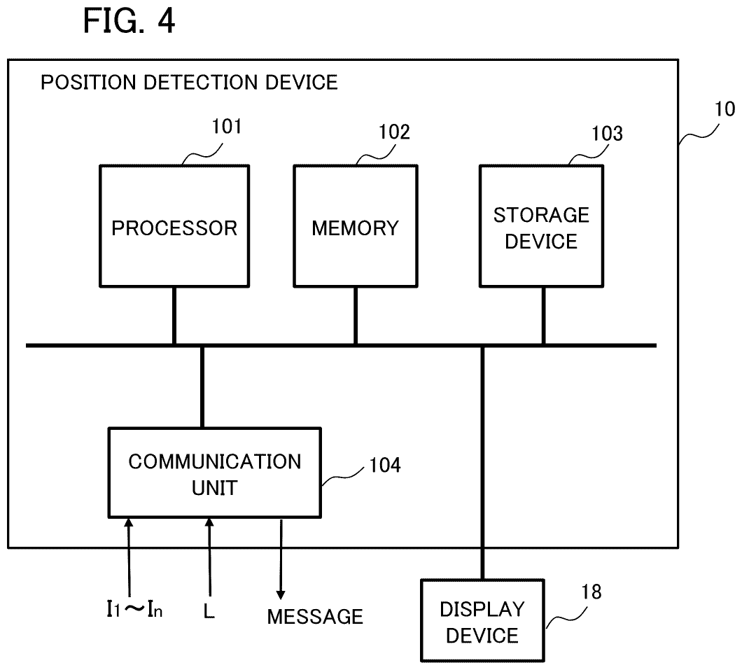

FIG. 4 is a diagram showing a hardware configuration of the position detection device 10 according to the first embodiment. As shown in FIG. 4, the position detection device 10 includes a processor 101 such as a CPU (Central Processing Unit), a memory 102 as a volatile storage device, a nonvolatile storage device 103 such as a hard disk drive (HDD) or a solid state drive (SSD), and a communication unit 104 that executes communication with the outside. The memory 102 is a volatile semiconductor memory such as a RAM (Random Access Memory), for example.

Functions of the position detection device 10 are implemented by processing circuitry. The processing circuitry can be either dedicated hardware or the processor 101 executing a program stored in the memory 102 as a storage medium or a record medium. The storage medium may be a non-transitory computer-readable storage medium storing a program such as the position detection program. The processor 101 can be any one of a processing device, an arithmetic device, a microprocessor, a microcomputer, and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 101, the position detection program is implemented by software, firmware, or a combination of software and firmware. The software and the firmware are described as programs and stored in the memory 102. The processor 101 implements the functions of the units shown in FIG. 3 by reading out and executing the position detection program stored in the memory 102.

It is also possible to implement part of the position detection device 10 by dedicated hardware and part of the position detection device 10 by software or firmware. As above, the processing circuitry is capable of implementing the above-described functions by hardware, software, firmware, or a combination of some of these means.

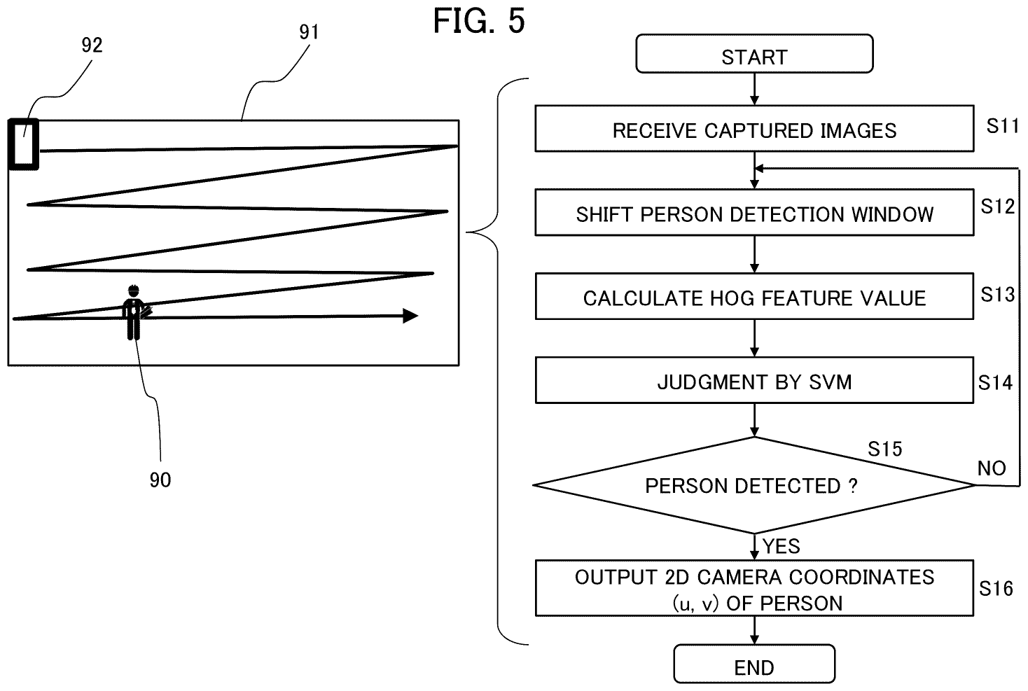

FIG. 5 is a flowchart showing a process executed by the person detection unit 14 of the position detection device 10 according to the first embodiment. The person detection unit 14 receives the images I₁-Iₙ first (step S11). Subsequently, the person detection unit 14 executes a process for detecting the person 90 by successively moving a detection window 92 in an image 91 of each frame (steps S12-S14). Specifically, the person detection unit 14 repeats a process (steps S12-S15) of calculating a HOG (Histograms of Oriented Gradients) feature value as a feature value obtained by representing gradient directions of luminance (color, brightness) in a local region as a histogram by successively moving the detection window 92 in the image 91 of each frame, making a judgment by SVM (Support Vector Machine) as a pattern recognition model using supervised learning, and judging whether or not the person 90 has been detected successfully. Subsequently, the person detection unit 14 outputs the 2D camera coordinates (u, v) as 2D coordinates of the person 90.

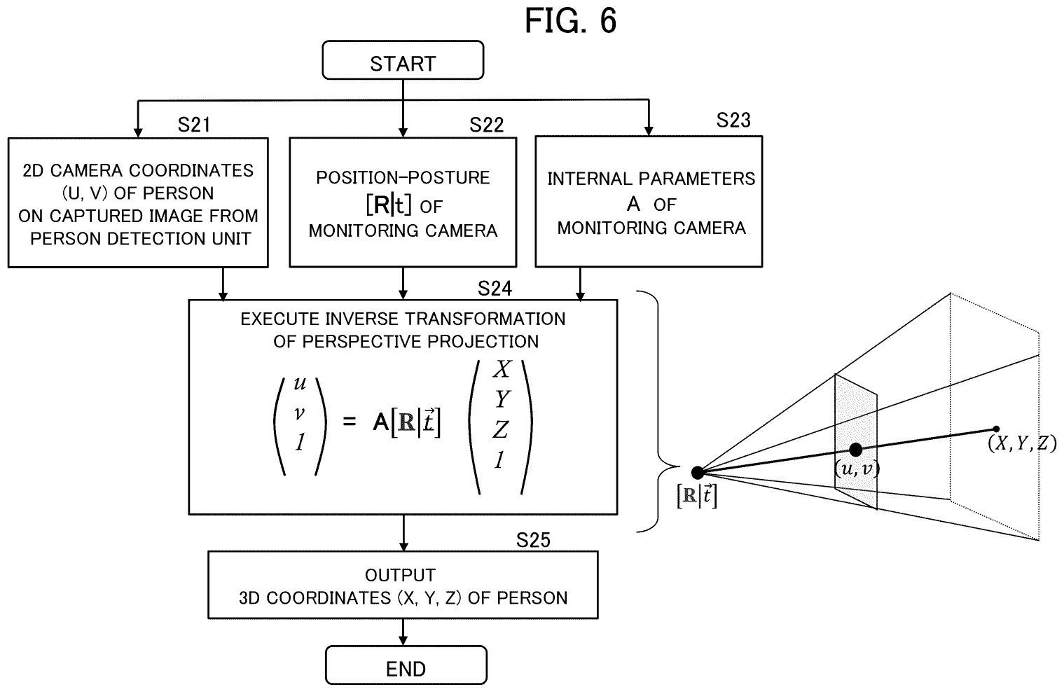

FIG. 6 is a flowchart showing a process executed by the coordinate transformation unit 15 of the position detection device 10 according to the first embodiment. First, the coordinate transformation unit 15 receives the 2D camera coordinates (u, v) of the person 90 on the captured image from the person detection unit 14 (step S21), acquires [R|t] representing position-posture information on the monitoring camera (step S22), and acquires internal parameters A of the monitoring camera (step S23). Subsequently, inverse transformation of perspective projection is executed according to the following expression (1) (step S24):

$$( \begin{matrix}u \\ v \\ 1\end{matrix} ) = A [ R \vert \vec{t} ] ( \begin{matrix}X \\ Y \\ Z \\ 1\end{matrix} ) . \qquad ( 1 )$$

Here,

### A

represents the internal parameters of the monitoring camera, and

[R|\vec{t}]

represents external parameters of the monitoring camera.

Subsequently, the coordinate transformation unit 15 outputs the 3D coordinates (X, Y, Z) of the person 90.

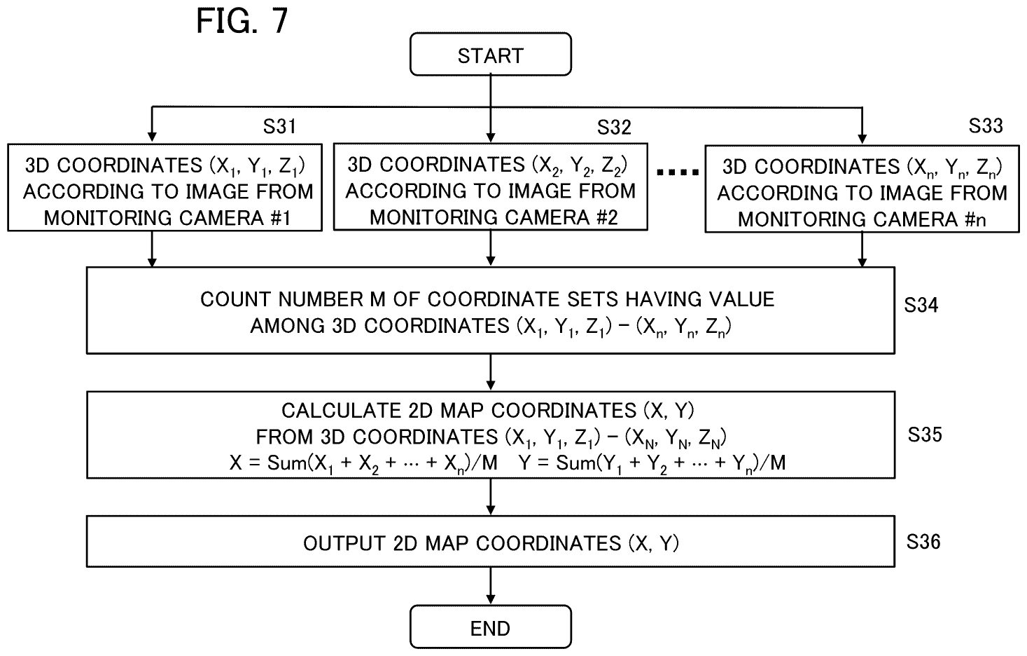

FIG. 7 is a flowchart showing a process executed by the map coordinate determination unit 16 of the position detection device 10 according to the first embodiment. The map coordinate determination unit 16 acquires the 3D coordinates (X₁, Y₁, Z₁) according to the image from the monitoring camera #1, the 3D coordinates (X₂, Y₂, Z₂) according to the image from the monitoring camera #2, . . . , and the 3D coordinates (Xₙ, Yₙ, Zₙ) according to the image from the monitoring camera #n (steps S31 to S33).

Subsequently, the map coordinate determination unit 16 counts the number of coordinate sets having a value among the 3D coordinates (X₁, Y₁, Z₁)-(Xₙ, Yₙ, Zₙ) (i.e., count M).

Subsequently, the map coordinate determination unit 16 outputs the values of the 2D map coordinates (X, Y) based on the values of the 3D coordinates (X₁, Y₁, Z₁)-(Xₙ, Yₙ, Zₙ) by using weighted average calculation formulas represented by the following expressions:

$$X = \frac{Sum ( {X}_{1} + {X}_{2} + ⋯ + {X}_{n} )}{M}$$

$$Y = \frac{Sum ( {Y}_{1} + {Y}_{2} + ⋯ + {Y}_{n} )}{M} .$$

Subsequently, the map coordinate determination unit 16 outputs the values of the 2D map coordinates (X, Y).

As described above, by using the position detection device 10, the position detection method and the position detection program according to the first embodiment, the position of the person 90 can be detected based on the images I₁-Iₙ from the plurality of monitoring cameras 11_1-11_n differing in the position-posture.

Further, by using the plurality of monitoring cameras 11_1-11_n, the accuracy of the position detection can be increased.

Furthermore, since the camera parameters of the plurality of monitoring cameras 11_1-11_n do not need to be common, the position of a person can be detected with high accuracy by using images from already-existing monitoring cameras.

### Second Embodiment

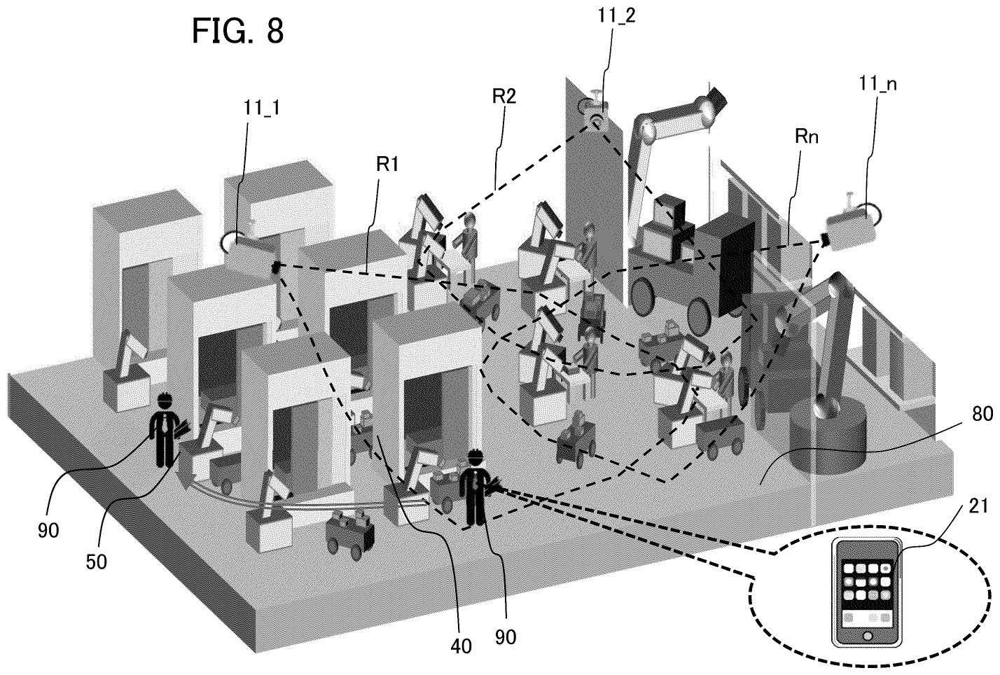

FIG. 8 is a diagram showing the monitoring cameras 11_1-11_n and a mobile terminal 21 as a configuration used for the position detection by a position detection device 20 according to a second embodiment. The mobile terminal 21 is carried by the person 90 as the detection target. One or more monitoring cameras 11_1-11_n have been installed in the predetermined area 80 in which the instrument panels 40 and the machines 50 have been set. The monitoring cameras 11_1-11_n may also be already-existing cameras. The monitoring cameras 11_1-11_n respectively capture images of the image capturing ranges R1-Rn and transmit the images I₁-Iₙ to the position detection device 20. The position detection device 20 calculates the 2D map coordinates (X, Y) of the person 90 based on the images I₁-Iₙ and generates the image data for making the display device 18 display the information indicating the 2D map coordinates (X, Y) on the map 81 of the area 80.

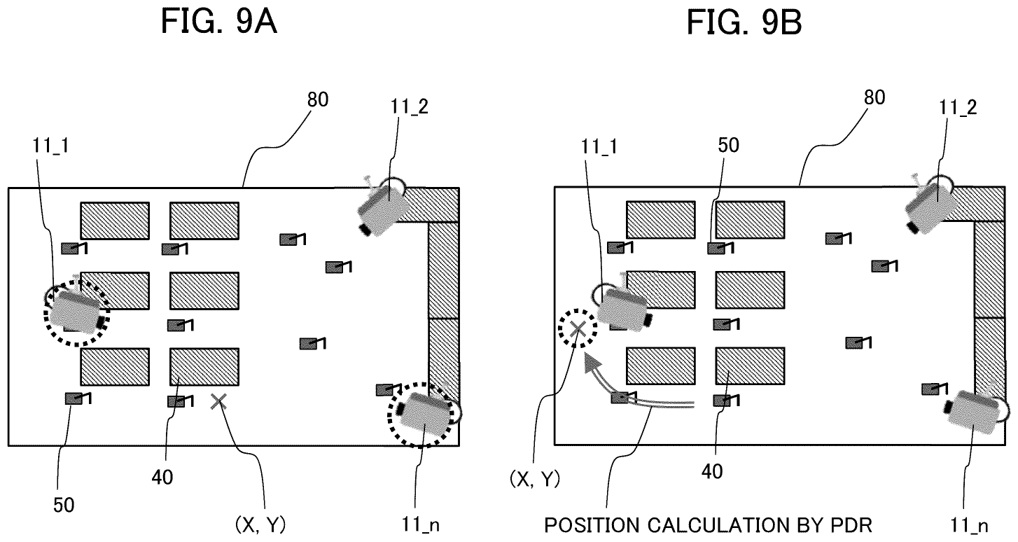

FIG. 9A is a diagram showing the 2D map coordinates (X, Y) of the person 90 detected based on the images I₁-Iₙ captured by the monitoring cameras 11_1-11_n on the map 81 of the area 80. FIG. 9B is a diagram showing 2D map coordinates (X, Y) based on 2D coordinates (Xp, Yp) of the person 90 detected by pedestrian dead reckoning (PDR) on the map 81 of the area 80. FIG. 9A shows an example of the 2D map coordinates (X, Y) calculated by using two monitoring cameras 11_1 and 11_n, and FIG. 9B shows the 2D map coordinates (X, Y) obtained as a result of position calculation by PDR after the person 90 moved to the outside of the image capturing ranges of the monitoring cameras.

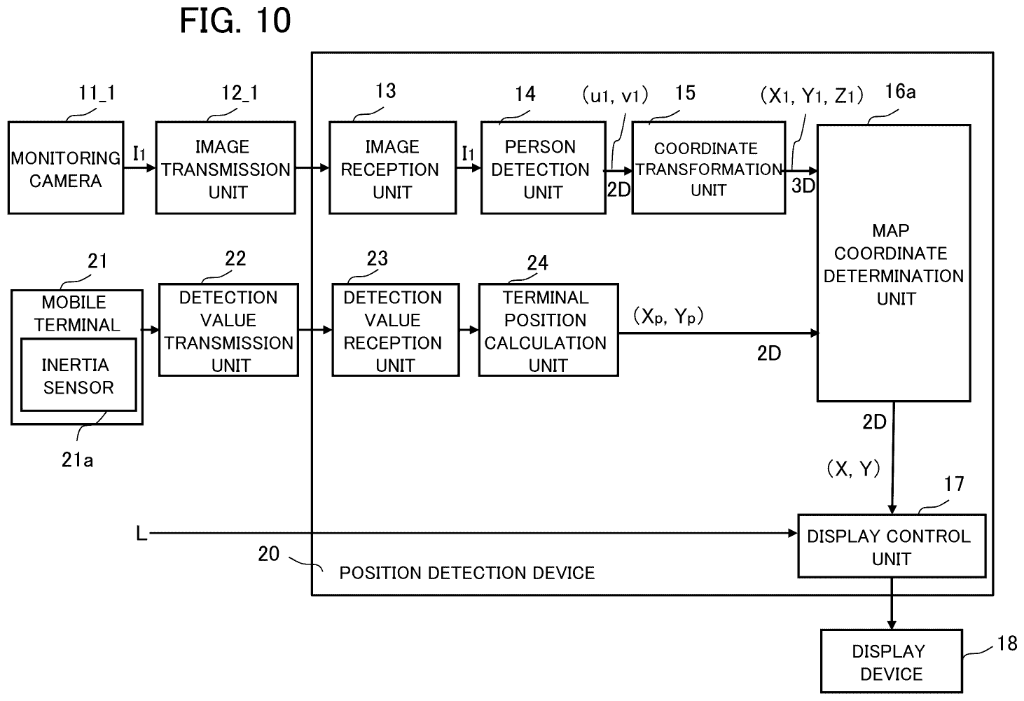

FIG. 10 is a functional block diagram schematically showing the configuration of the position detection device 20 according to the second embodiment. The position detection device 20 is a device capable of executing a position detection method according to the second embodiment. The position detection device 20 is capable of executing the position detection method according to the second embodiment by executing a position detection program. As shown in FIG. 10, the position detection device 20 includes the image reception unit 13, the person detection unit 14, the coordinate transformation unit 15, a detection value reception unit 23, a terminal position calculation unit 24, a map coordinate determination unit 16a and the display control unit 17. The hardware configuration of the position detection device 20 is the same as that in FIG. 4.

The image reception unit 13 receives images I₁ captured by one or more monitoring cameras 11_1 and transmitted from the image transmission unit 12_1 and sends the images I₁ to the person detection unit 14. The person detection unit 14 receives the images I₁, executes a process for detecting the person 90 in the images I₁, and outputs the 2D camera coordinates (u₁, v₁) indicating the position of the detected person 90. The coordinate transformation unit 15 is a 2D/3D coordinate transformation unit. The coordinate transformation unit 15 transforms the 2D camera coordinates (u₁, v₁) to the 3D coordinates (X₁, Y₁, Z₁) represented in a predetermined common coordinate system.

The detection value reception unit 23 receives detection values as sensor values of an inertia sensor 21a of the mobile terminal 21 carried by the person 90 and outputs the detection values to the terminal position calculation unit 24. The inertia sensor 21a is a device capable of detecting translational movement and rotational movement in directions of three axes orthogonal to each other, for example. In general, the inertia sensor is a device that detects the translational movement with an acceleration sensor [m/s²] and detects the rotational movement with an angular speed (gyro) sensor [deg/sec].

The terminal position calculation unit 24 calculates terminal position coordinates (Xₚ, Yₚ) representing the position of the mobile terminal 21.

The map coordinate determination unit 16a calculates the 2D map coordinates (X, Y) based on the 3D coordinates in periods in which the person 90 is detected, and calculates the 2D map coordinates (X, Y) based on the terminal position coordinates (Xₚ, Yₚ) in periods in which the person 90 is not detected.

The display control unit 17 outputs the image data in which the position information on the 2D map coordinates (X, Y) is superimposed on the map 81 of the area 80. The display device 18 displays the map 81 of the area 80 and the position information on the 2D map coordinates (X, Y). The map 81 is displayed based on the map information L acquired from the external storage device.

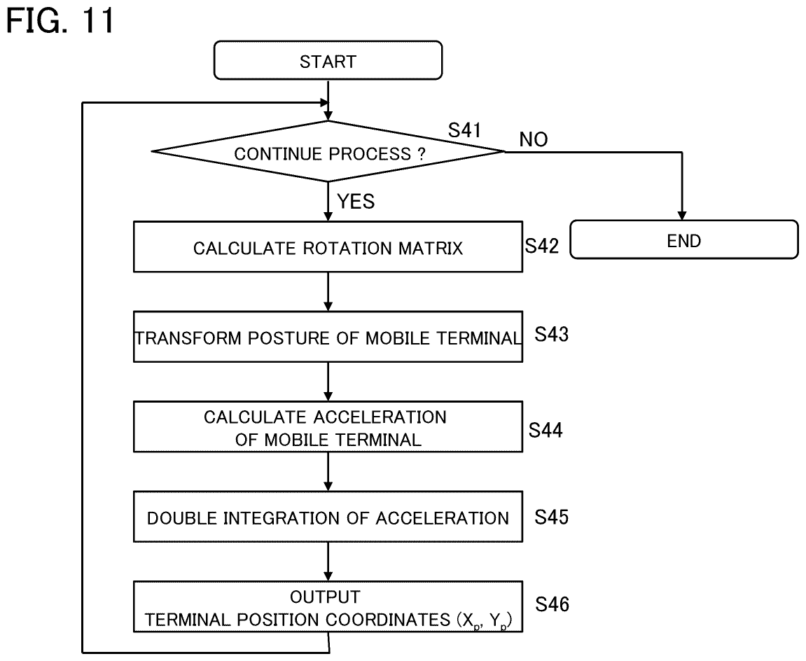

FIG. 11 is a flowchart showing a process executed by the terminal position calculation unit 24 of the position detection device 20 according to the second embodiment. In FIG. 11, the terminal position calculation unit 24 calculates a rotation matrix from the detection values (step S42), transforms the posture of the mobile terminal 21 (step S43), calculates acceleration of the mobile terminal 21 (step S44), calculates displacement by performing double integration on the acceleration (step S45), and outputs terminal position coordinates (Xₚ, Yₚ) based on the displacement (step S46). The terminal position calculation unit 24 repeats the above process (steps S42 to S46) until the position detection by the monitoring cameras is restarted, for example (step S41).

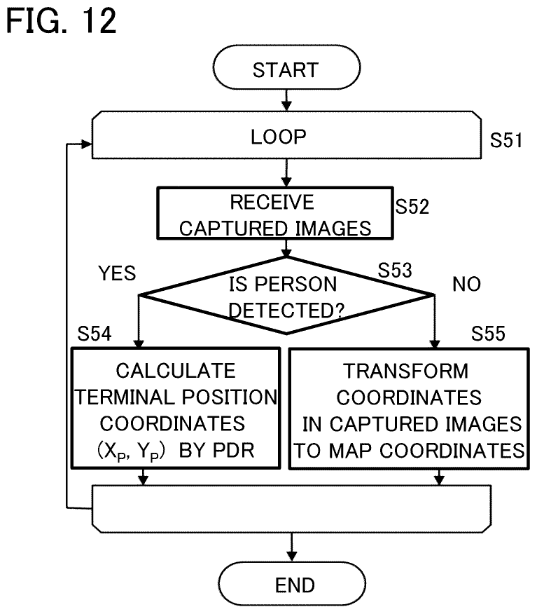

FIG. 12 is a flowchart showing a process executed by the map coordinate determination unit 16a of the position detection device 20 according to the second embodiment. The map coordinate determination unit 16a receives images in a loop process (step S51), and outputs the 2D map coordinates (X, Y) based on the images (step S54) if the person 90 is detected (YES in the step S53), or outputs the terminal position coordinates (Xₚ, Yₚ) obtained by PDR based on the detection values of the inertia sensor 21a as the 2D map coordinates (X, Y) (step S55) if the person is not detected (NO in the step S53).

As described above, by using the position detection device 20, the position detection method and the position detection program according to the second embodiment, it is possible to output the 2D map coordinates (X, Y) by a method with relatively high accuracy based on the images I₁ or the like when the position of the person 90 can be detected based on the images from one or more monitoring cameras, and it is possible to output the terminal position coordinates calculated based on the detection values of the inertia sensor 21a as the 2D map coordinates (X, Y) when the person 90 is outside the image capturing ranges.

Further, disadvantage of the position detection by using PDR with relatively low accuracy can be mitigated by taking a countermeasure such as comparing the calculation result of PDR with calculation results in the past and notifying that the accuracy is low when there is an error greater than or equal to a predetermined value.

### Third Embodiment

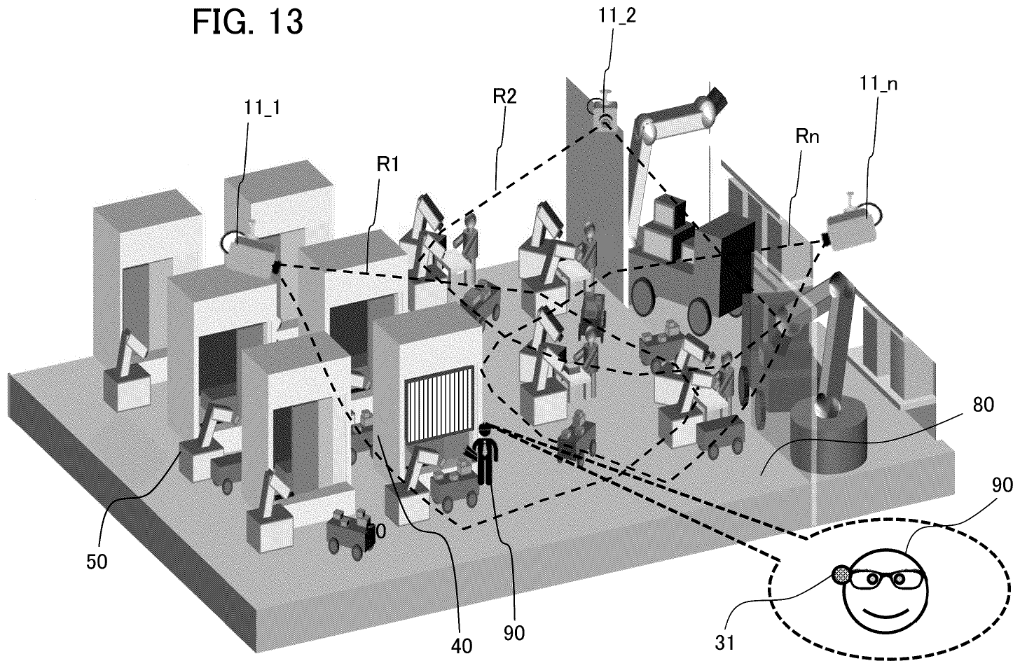

FIG. 13 is a diagram showing the monitoring cameras 11_1-11_n and a wearable camera 31 as a configuration used for the position detection by a position detection device 30 according to a third embodiment. The wearable camera 31 is a small-sized camera that captures an image in the direction of the line of sight of the worker as the person 90, and is referred to also as a smart glass. The wearable camera 31 is carried by the person 90. One or more monitoring cameras 11_1-11_n have been installed in the predetermined area 80 in which the instrument panels and the machines 50 have been set. The monitoring cameras 11_1-11_n may also be already-existing cameras. The monitoring cameras 11_1-11_n respectively capture images of the image capturing ranges R1-Rn and transmit the images I₁-Iₙ to the position detection device 30. The position detection device 30 calculates the 2D map coordinates (X, Y) of the person 90 based on the images I₁-Iₙ and generates image data for making the display device display the information indicating the 2D map coordinates (X, Y) on the map 81 of the area 80.

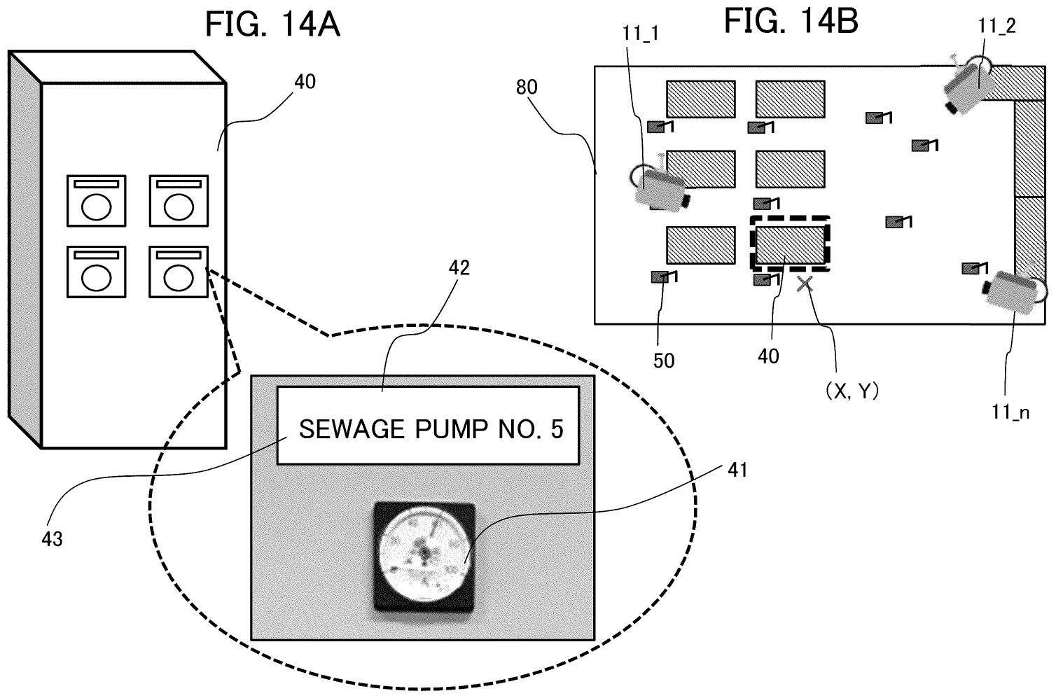

FIG. 14A is a diagram showing an example of the instrument panel 40, a device 41 such as an instrument, and a nameplate 42. FIG. 14B is a diagram showing the 2D map coordinates (X, Y) on the map 81 of the area 80 based on a character string recognized by using an image of the nameplate 42.

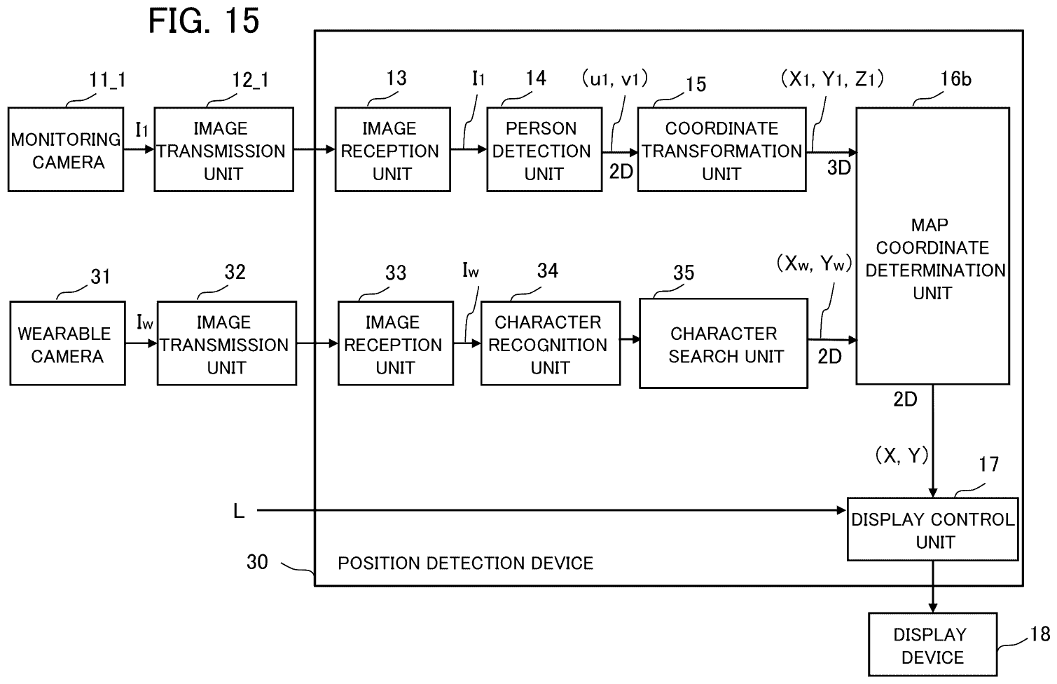

FIG. 15 is a functional block diagram schematically showing the configuration of the position detection device 30 according to the third embodiment. The position detection device 30 is a device capable of executing a position detection method according to the third embodiment. The position detection device 30 is capable of executing the position detection method by executing a position detection program. As shown in FIG. 15, the position detection device 30 includes the image reception unit 13, the person detection unit 14, the coordinate transformation unit 15, an image reception unit 33, a character recognition unit 34, a character search unit 35, a map coordinate determination unit 16b and the display control unit 17. The hardware configuration of the position detection device 30 is the same as that in FIG. 4.

The person detection unit 14 receives an image captured by the monitoring camera 11_1, executes the process for detecting the person 90 in the images I₁, and outputs the 2D camera coordinates (u₁, v₁) indicating the position of the detected person 90.

The coordinate transformation unit 15 transforms the 2D camera coordinates to the 3D coordinates (X₁, Y₁, Z₁) represented in a predetermined common coordinate system.

The character recognition unit 34 recognizes the character string 43 on the nameplate 42 of the device 41 in a wearable camera image I W captured by the wearable camera 31 when the wearable camera 31 is worn by the person 90.

The character search unit 35 searches a layout chart of the devices in the area 80 (e.g., the map 81 describing the device layout) for the recognized character string 43.

When the recognized character string 43 is found in the layout chart, the map coordinate determination unit 16b determines the 2D map coordinates (X, Y) based on the position where the character string 43 is found. When the recognized character string 43 is not found in the layout chart, the map coordinate determination unit 16b calculates the 2D map coordinates (X, Y) based on the 3D coordinates.

The display control unit 17 outputs the image data in which the position information on the 2D map coordinates (X, Y) is superimposed on the map 81 of the area 80.

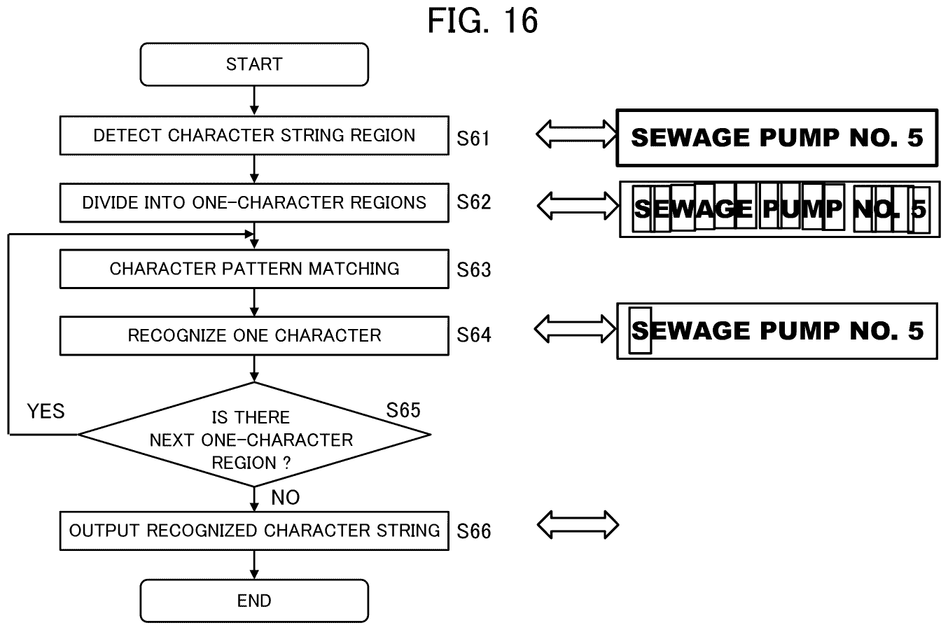

FIG. 16 is a flowchart showing a process executed by the character recognition unit 34 of the position detection device 30 according to the third embodiment. The character recognition unit 34 detects a character string region (step S61), divides the character string region into one-character regions (step S62), executes character pattern matching (step S63), determines one character (step S64), and judges whether or not there is the next one character (step S65). When there is the next one character (YES in the step S65), the character recognition unit 34 repeats the steps S63 to S65. When there is no next one character (NO in the step S65), the character recognition unit 34 outputs the character string (step S66).

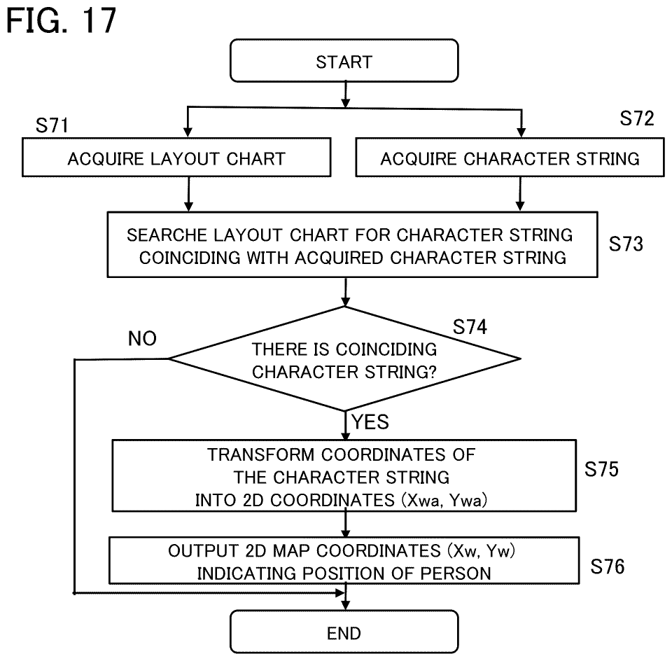

FIG. 17 is a flowchart showing a process executed by the character search unit 35 of the position detection device 30 according to the third embodiment. The character search unit 35 acquires the layout chart of the map 81 of the area 80 (step S71), acquires the character string (step S72), and searches the layout chart for a character string coinciding with the acquired character string (step S73). When there is a coinciding character string (YES in step S74), the character search unit 35 transforms the character string into 2D coordinates (step S75), and outputs the 2D map coordinates (X, Y) indicating the position of the person. When there is no coinciding character string (NO in the step S74), the character search unit 35 ends the character search.

As described above, by using the position detection device 30, the position detection method and the position detection program according to the third embodiment, when the character string 43 on the nameplate 42 is found based on the image from the wearable camera 31, the position of the nameplate 42 is outputted as the 2D map coordinates (X, Y). When the character string 43 on the nameplate 42 is not found, the position of the person 90 based on the image from the monitoring camera is outputted as the 2D map coordinates (X, Y). By such control, the accuracy of the position detection can be increased. In other words, the position detection accuracy can be increased since the position of the nameplate 42 is used for the position detection with priority over the calculation result of the captured image.

Further, even when the person is situated outside the image capturing range, the coordinates can be calculated based on the image from the wearable camera 31.

### DESCRIPTION OF REFERENCE CHARACTERS

10, 20, 30: position detection device, 11_1-11_n: monitoring camera, 14: person detection unit, 15: coordinate transformation unit, 16, 16a, 16b: map coordinate determination unit, 17: display control unit, 18: display device, 21: mobile terminal, 21a: inertia sensor, 24: terminal position calculation unit, 31: wearable camera, 34: character recognition unit, 35: character search unit, 41: device (instrument), 42: nameplate, 43: character string, 90: person, I₁-Iₙ: image, I_{w}: wearable camera image, (u₁, v₁)-(uₙ, vₙ): two-dimensional camera coordinates (2D camera coordinates), (X₁, Y₁, Z₁)-(Xₙ, Yₙ, Zₙ): three-dimensional coordinates (3D coordinates), (X, Y): two-dimensional map coordinates (2D map coordinates), (Xₚ, Yₚ): terminal position coordinates, (X_{w}, Y_{w}): wearable camera coordinates.

What is claimed is:

1. A position detection device comprising:
processing circuitry
to receive an image captured by a monitoring camera, to execute a process for detecting a person in the image, and to output two-dimensional camera coordinates indicating a position of the detected person;
to transform the two-dimensional camera coordinates to three-dimensional coordinates represented in a predetermined common coordinate system;
to recognize a character string on a nameplate of a device in a wearable camera image captured by a wearable camera when the wearable camera is worn by the person;
to search a layout chart of the device for the recognized character string;
to determine two-dimensional map coordinates based on a position where the character string is found when the recognized character string is found in the layout chart, and to calculate the two-dimensional map coordinates based on the three-dimensional coordinates when the recognized character string is not found in the layout chart; and
to acquire a map and to output image data in which position information on the two-dimensional map coordinates is superimposed on the map.

2. A position detection method executed by a position detection device, the method comprising:
receiving an image captured by a monitoring camera, executing a process for detecting a person in the image, and outputting two-dimensional camera coordinates indicating a position of the detected person;
transforming the two-dimensional camera coordinates to three-dimensional coordinates represented in a predetermined common coordinate system;
recognizing a character string on a nameplate of a device in a wearable camera image captured by a wearable camera when the wearable camera is worn by the person;
searching for a position of the person based on a result of matching between the recognized character string and a character string included in a layout chart of the device;
determining two-dimensional map coordinates based on a position where the character string is found when the recognized character string is found in the layout chart, and calculating the two-dimensional map coordinates based on the three-dimensional coordinates when the recognized character string is not found in the layout chart; and
acquiring a map and outputting image data in which position information on the two-dimensional map coordinates is superimposed on the map.

3. A non-transitory computer-readable storage medium storing a position detection program that causes a computer to execute the position detection method according to claim 2.
